(19) United States
(12) Patent Application Publication
(10) Pub. No.: US 2003/0209669 A1
(43) Pub. Date: Nov. 13, 2003

(54) Miniaturized infrared gas analyzing apparatus

(76) Inventor: Bruce C. S. Chou, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/141,124

(22) Filed: May 9, 2002

(51) Int. Cl. G01N 21/35

(52) U.S. Cl. 250/343

(57) ABSTRACT

The present invention provides a miniaturized infrared gas analyzing apparatus, which is composed of various kinds of micro elements (e.g., infrared light source, tunable filter, and thermal detector) fabricated by means of silicon micromachining technology so as to meet the requirements of low power consumption and low cost and apply to qualitative and quantitative analysis of infrared absorption spectra of various kinds of gases. The miniaturized infrared gas analyzing apparatus comprises an infrared emitting unit, an infrared collimator, a bandpass and spatial filter, a tunable filter unit, a sensing unit, and a microprocessing unit. The infrared emitting unit utilizes the blackbody radiation principle of thermo-resistive filament to radiate out a wide infrared spectrum and serves as a point light source. The infrared collimator converts the infrared emitting unit into a collimated infrared light beam. The bandpass and spatial filter allows the transmission of an wide passband including at least the absorption wavelength of a specific gas to be sensed, and only let the infrared light beam passing within a specific geometric region. The Fabry-Perot tunable filter unit utilizes electric field to control the length of resonant cavity so that only the narrow-bandwidth wavelength matching the absorption spectrum of the sensed gas can pass at a time. The sensing unit determines the concentration of the sensed gas according to the light intensity. And, a microprocessing unit is used for controlling of all the components mentioned above.

### FIELD OF THE INVENTION

The present invention relates to an infrared gas analyzing apparatus and, more particularly, to a miniaturized infrared gas analyzing apparatus with consisting components fabricated on the basis of silicon micromachining technology and methods of assembling thereof.

### BACKGROUND OF THE INVENTION

Solid-state detectors made of metallic oxide (e.g., tin oxide) are the mainstream of present gas detectors. The sensing principle is based on variation of resistance generated through reacting with specific gas at high temperature (usually 300˜400° C.). The solid-state gas detectors could be mainly distinguished into two types: conventional- and micromachined-type, which only differ in that the micromachined type consumes lower power and thus suitable for portable products. However, the reliability of micromachined type gas detector is still a difficult problem to be overcome.

No matter the conventional- or the micromachined-type, the utmost drawback is that it cannot effectively discriminate of gas species (determining gas types). With carbon monoxide and alcohol as examples, they both can react with tin oxide. It cannot distinguish which one (carbon monoxide or alcohol) causes the reaction once gas is sensed. Besides, the solid-state gas detectors have a lower sensitivity, and are more subject to environmental influence (e.g., humidity and temperature). Moreover, material operated at high temperature could produce material fatigue problem.

By the Infrared (IR) absorption spectra of various gases can thoroughly solve the above problems of solid-state gas detectors. FIG. 1 shows the characteristics of infrared absorption spectra of different gases. It can be seen from the figure, different gases have different IR absorption wavelengthes (e.g., CO₂: 4.3 μm, CO: 4.7 μm). Various kinds of narrow bandpass filters made of optical coating can perform accurately discrimination of different gases due to their IR absorption characteristics.

However, the IR gas detector in prior art consumes large power because of conventional resistor-type infrared light source. Moreover, the low yield of various kinds of bandpass filters made of optical coating and central wavelength shifting of those bandpass filters resulted from environmental effects are also serious problem. If many kinds of gases need to be sensed, it is necessary to build several sets of bandpass filters, resulting in a higher price. Please refer to U.S. Pat. Nos. 5,852,308; 5,468,961; and 5,861,545.

In consideration of the above problems, the present invention aims to propose a novel miniaturized infrared gas analyzing apparatus based on various kinds of miniaturized elements (e.g., infrared light source, bandpass and spatial filter, tunable filter, and thermal detector) fabricated by means of silicon micromachining technology so as to meet the requirements of low power consumption and low cost and apply to qualitative and quantitative analysis of infrared absorption spectra of various kinds of gases.

### SUMMARY OF THE INVENTION

Accordingly, the object of the present invention is to provide a miniaturized infrared gas analyzing apparatus with consisting components fabricated on the basis of silicon micromachining technology and assembly method thereof.

One embodiment of the present invention relates to the design of a miniaturized infrared gas analyzing apparatus, which comprises an infrared emitting unit, an infrared collimator, a bandpass and spatial filter, a tunable filter unit, a sensing unit, and a microprocessing control unit. The infrared emitting unit utilizes the blackbody radiation principle of thermo-resistive filament to radiate out a wide infrared spectrum and serves as a point light source. The infrared collimator converts the light from the point IR source a collimated beam of light. The bandpass and spatial filter allows the transmission of an wide passband including at least the absorption wavelength of a specific gas to be sensed, and only let the infrared light beam passing within a defined geometric region. The Fabry-Perot tunable filter unit utilizes electric field to control the length of the air resonant cavity so that only the narrow-bandwidth wavelength matching the absorption spectrum of the sensed gas can pass at a time. The sensing unit determines the concentration of the sensed gas according to the light intensity. And, a microprocessing unit is used for controlling of all the components mentioned above.

Another embodiment of the present invention relates to the infrared emitting unit, which comprises a micro thermo-resistive infrared emitter fabricated by means of silicon micromachining technology and a constant-temperature (resistance) driving circuit. Based on the blackbody radiation principle, the micro thermo-resistive infrared emitter radiates out light covering all the optical spectrum. The constant-temperature circuit fixes and stabilizes the temperature of the micro thermo-resistive infrared emitter so that the radiation intensity will not be affected by drifting of the ambient temperature.

Yet another embodiment of the present invention relates to the bandpass and spatial filter, which comprises a (100)-oriented silicon substrate having a first surface and a second surface. A optical coating allowing the transmission of a wide passband including at least the absorption wavelength of a specific gas to be sensed is formed on the first surface of the silicon substrate. A metal film having an opening of specific geometric shape as a spatial filter is further formed on the optical coating. A portion of silicon substrate is anisotropically etched underneath the opening of the metal film to form a V-groove, therefore, exposing a portion of the bandpass optical coating.

Yet another embodiment of the present invention relates to the tunable filter unit, which comprises a micro tunable filter fabricated by means of silicon micromachining technology, and a drive and oscillation circuit. The micro tunable filter utilizes electric field to tune the length of resonant cavity that only the narrow-bandwidth wavelength matching the absorption spectrum of the sensed gas can pass at a time. The driving and oscillation circuit provides a DC voltage superimposed with an oscillating AC voltage so that the micro tunable filter has both the functions of narrow bandpass filter and optical modulator.

Still yet another embodiment of the present invention relates to the sensing unit, which comprises a micro thermal detector fabricated by means of silicon micromachining technology, and a frequency-locking readout circuit. Frequency-locking of the output AC signal of the micro thermal detector with the modulation frequency of the driving and oscillation circuit can enhance the signal to noise ratio (S/N ratio) of measurement and avoid noise problem caused by environmental effect (ambient temperature drifting).

The various objects and advantages of the present invention will be more readily understood from the following detailed description when read in conjunction with the appended drawings, in which:

### BRIEF DESCRIPTION OF THE DRAWINGS

FIG. 1 shows the characteristics of infrared absorption spectrum of different gases;

FIG. 2 shows functional blocks of the miniaturized infrared gas analyzing apparatus of the present invention;

FIG. 3 shows the arrangement of subassemblies of the miniaturized infrared gas analyzing apparatus of the present invention;

FIG. 4a is a top view of a micro thermo-resistive infrared emitter according to an embodiment of the present invention;

FIG. 4b is a cross-sectional view along line A-A of FIG. 4a;

FIG. 5a is a top view of a micro thermo-resistive infrared emitter according to another embodiment of the present invention;

FIG. 5b is a cross-sectional view along line A-A of FIG. 5a;

FIG. 6 is a cross-sectional view of a micro bandpass and spatial filter of the present invention;

FIG. 7 is a cross-sectional view of a micro tunable filter according to an embodiment of the present invention;

FIG. 8a is a top view of a micro thermopile detector according to an embodiment of the present invention;

FIG. 8b is a cross-sectional view along line A-A of FIG. 8a;

FIG. 9a is a top view of a micro thermopile detector according to another embodiment of the present invention; and

FIG. 9b is a cross-sectional view along line A-A of FIG. 9a.

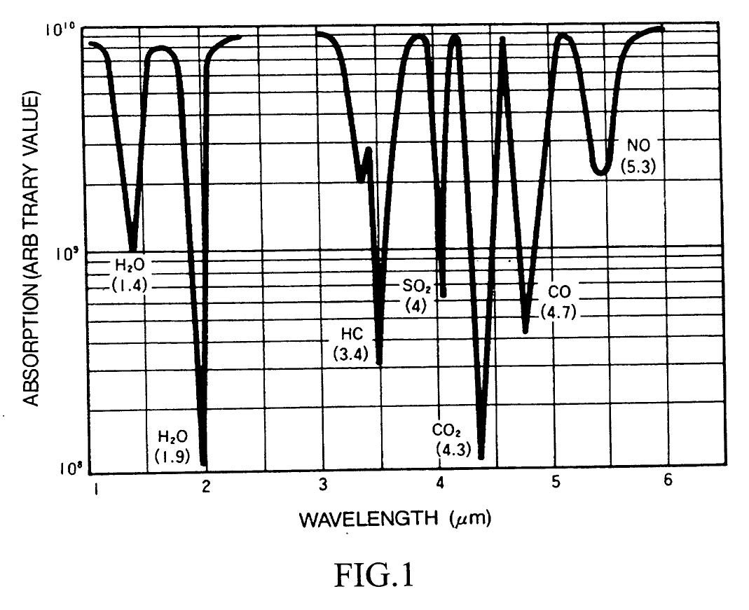

### DETAILED DESCRIPTION OF THE PREFERRED EMBODIMENTS

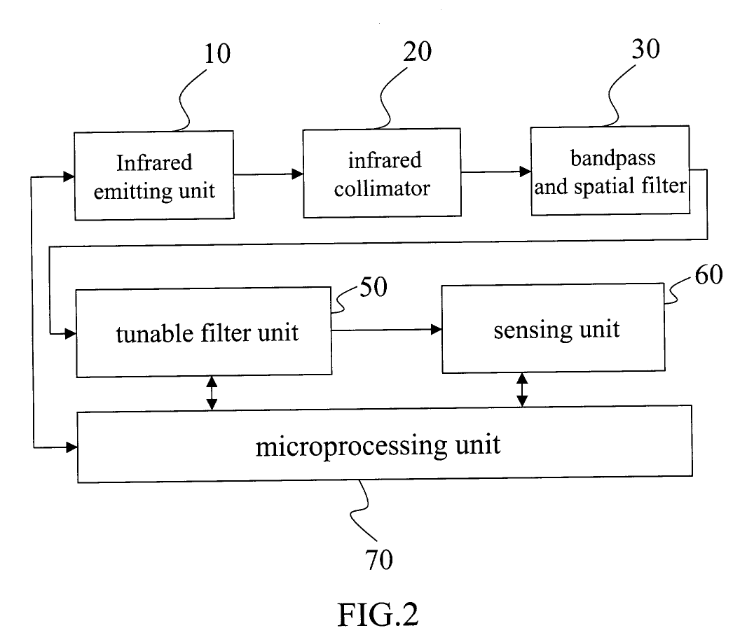

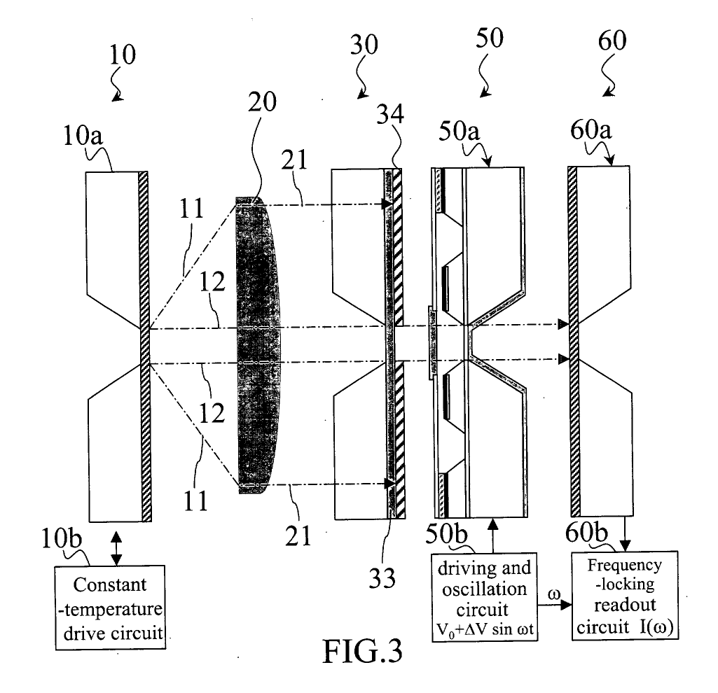

FIG. 2 shows the functional blocks of a miniaturized infrared gas analyzing apparatus of the present invention, which comprises an infrared emitting unit 10, an infrared collimator 20, a bandpass and spatial filter 30, a tunable filter unit 50, a sensing unit 60, and a microprocessing unit 70. The infrared emitting unit 10 utilizes the blackbody radiation principle of thermo-resistive filament to radiate out a wide infrared spectrum and serves as a point light source. The infrared collimator 20 converts the infrared emitting unit 10 into a collimated infrared light beam. The bandpass and spatial filter 30 allows the transmission of a wide passband including at least the absorption wavelength of a specific gas to be sensed, and only let the infrared light beam passing within a specific geometric region. The Fabry-Perot tunable filter unit 50 utilizes electric field to control the length of the air resonant cavity so that only the narrow-bandwidth wavelength matching the absorption spectrum of the sensed gas can pass at a time. The sensing unit 60 determines the concentration of the sensed gas according to the light intensity. And, a microprocessing unit 70 is used for controlling all the components mentioned above. FIG. 3 shows the arrangement of the miniaturized infrared gas analyzing apparatus of the present invention. As shown in FIG. 3, the infrared emitting unit 10 comprises a thermo-resistive infrared emitter 10a fabricated by means of silicon micromachining technology and a constant-temperature (-resistance) drive circuit 10b. The micro thermo-resistive infrared emitter 10a can be viewed as a point light source due to its small dimension of hundreds of micrometers. According to the blackbody radiation principle, it will radiate in all directions and optical spectrum. The infrared collimator 20 converts the light beam (the cone region covered by light beam 11) into a collimated light beam 21. The suitable material of the infrared collimator 20 is material having good transmittance for wavelength of 3˜5 μm or 2˜8 μm like silicon, sapphire, and magnesium fluoride.

The micro bandpass and spatial filter 30 comprises a bandpass optical film 33 and a metal layer 34 having an opening of circular or square shape as a spatial filter. The main function of the bandpass optical film 33 is to define the allowed IR passband matching to the desired gases detection. The spatial filter 34 only let a portion of the light beam 21 pass through the circular or square opening of the metal layer 34 (i.e., the region covered by the light beam 12) so as to match the mirror area of a micro tunable filter 50a described below.

A micro Fabry-Perot tunable filter 50a utilizes electric field to change the length of optical resonant cavity allowing a specific narrowband wavelength transmission (the infrared absorption wavelength of the sensed gas). A driving and oscillation circuit 50b provides a DC voltage V₀ and an oscillating AC voltage ΔV sin ωt to let the tunable filter 50a have both the functions of narrow bandpass filter and optical modulator.

A micro thermal detector 60a is used to detect the intensity of the passed narrowband wavelength after the tunable filter 50a. A frequency-locking readout circuit 60b compares the output AC signal I(ω) of the infrared detector 60a with the modulation frequency ω of the driving oscillation circuit 50b to enhance the S/N ratio of measurement and avoid noise problem caused by environmental effect.

In order to more clearly illustrate the superiority of the miniaturized elements fabricated by means of silicon micromachining technology over conventional elements, some units will be described in detail below.

Micro Thermo-Resistive Infrared Emitter

The way of utilizing a heating resistor to generate infrared light is based on the blackbody radiation principle. From the Wien's displacement law, the relation between the temperature and the wavelength λ with maximum exitance of radiation is described by the following formula:

λT=2897.8 (μm K) (1)

The wavelength of maximal exitance of human body at 37° C. is 9.35 μm. When applying to infrared absorption spectrum (3˜5 μm or 2˜8 μm) of gas, the temperature of thermo-resistive filament needs to be as high as several hundred degrees of Celsius to obtain enough radiation exitance. This lets the conventional thermo-resistive infrared emitter dissipate a very large power. Moreover, the conventional thermo-resistive infrared emitter is manufactured one by one resulting in poor quality control and increasing calibration problem. These are the reasons why the conventional thermo-resistive infrared emitter is so expensive. Silicon micromachining technology can be exploited to solve the problem of power consumption. Moreover, batch production of semiconductor fabrication process solves the problem of quality control. Please refer to J. S. Shie, Bruce C. S. Chou, and Y. M. Chen, “High performance Pirani vacuum gauge,” J. Vac. Sci. Tech. A, 13 (1995) 2972˜2979.

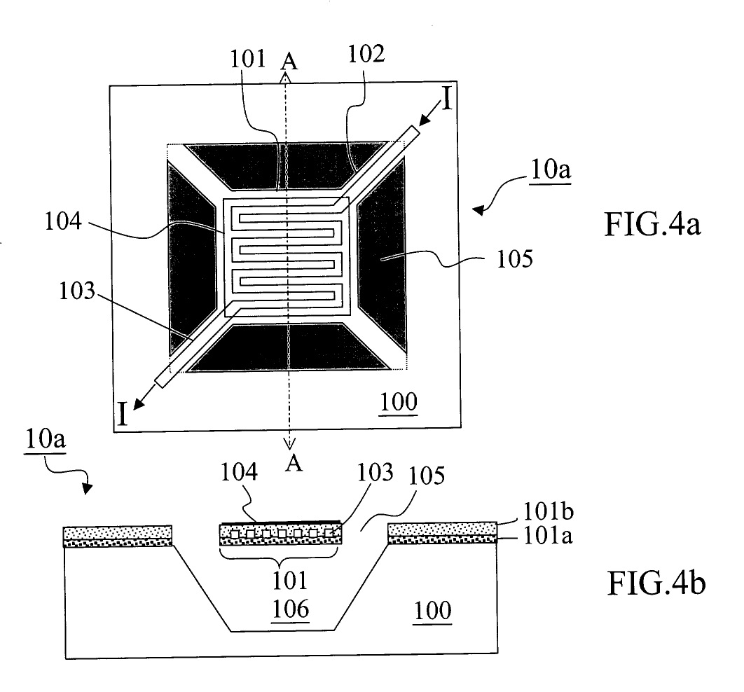

As shown in FIGS. 4a and 4b, a silicon substrate with (100) orientation is provided. A floating membrane 101 with four supporting beams extending and fixed to the edge of a V-groove 106. The V-groove 106 is defined by etching windows 105 and is formed by means of anisotropic etching technique. The membrane 101 and the supporting beams are composed of dielectrics 101a and 101b. The dielectrics 101a and 101b are usually silicon oxide or silicon nitride or their combination. A thermo-resistive material 103, usually being thermo-sensitive material with high temperature coefficient of resistance like silicon, platinum, and so on, is formed inside the membrane 101. A blackbody material 104, usually being a very thin metal film like gold-black or platinum-black, is fabricated on the utmost surface of the floating membrane 101 to increase radiation emissivity.

The micro thermo-resistive infrared emitter shown in FIG. 4 is a good thermal isolation structure to effectively reduce the thermal conductance value, usually between 1 μW/° C. to 10 μW/° C. Therefore, only a very small electric power is needed to generate very high temperature effect. For instance, if a polysilicon thermo-resistive filament is 1 KΩ, and the heating current is 1 mA, then 1 mW power can be generated. If the thermal conductance value of the micro thermal-resistive infrared emitter is 3 μW/° C., the temperature at the floating membrane 101 will be above 300° C., which can not be achieved by the conventional element. Simultaneously, very good thermal isolation effect between the floating membrane 101 and the substrate 100 can be achieved with the supporting beams 102. Moreover, the floating membrane 101 can be seen as an isothermal region, and the substrate is at the room temperature. Furthermore, the area of the membrane 101 is very small (˜mm×mm) so that it can be viewed as a point light source, which can much simplify subsequent optical design. Through a constant-temperature (-resistance) drive circuit 10b, the temperature of the floating membrane 101 can also be stabilized and fixed so that radiation intensity from a specific wavelength will not be influenced by ambient temperature drifting to reduce the sensitivity of measurement.

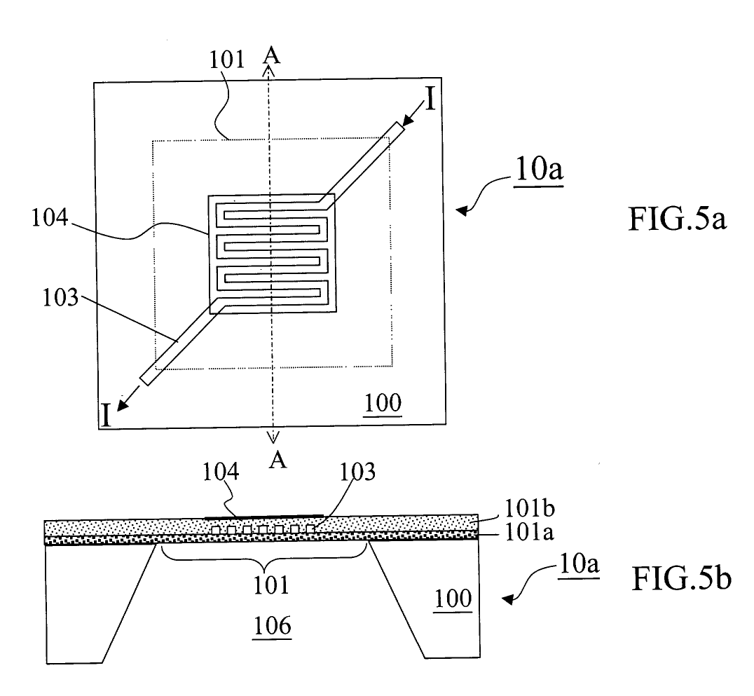

FIG. 5a is a top view of a micro thermo-resistive infrared emitter according to another embodiment of the present invention. FIG. 5b is a cross-sectional view along line A-A of FIG. 5a. The structure shown in FIGS. 5a and 5b only differs from that shown in FIGS. 4a and 4b in that the V-groove 106 is formed by means of backside anisotropic etching.

Micro Bandpass and Spatial Filter

A prior optical bandpass filter is fabricated by optical films on an optical substrate (e.g., a quartz glass). The requirement of quality thereof is that the optical substrate and the material of the optical film must have good transmittance for the demanded optical range (low absorption coefficient). The optical substrate, which is much thicker than the optical films, plays an important role on the situation, because they maybe absorbs more light intensity. Especially, for the bandwidth of infrared absorption spectrum (3˜5 μm or 2˜8 μm) of gas, infrared optical substrates of high transmittance are much less and more expensive. The present invention thus aims to propose a micro bandpass filter to solve the above problems.

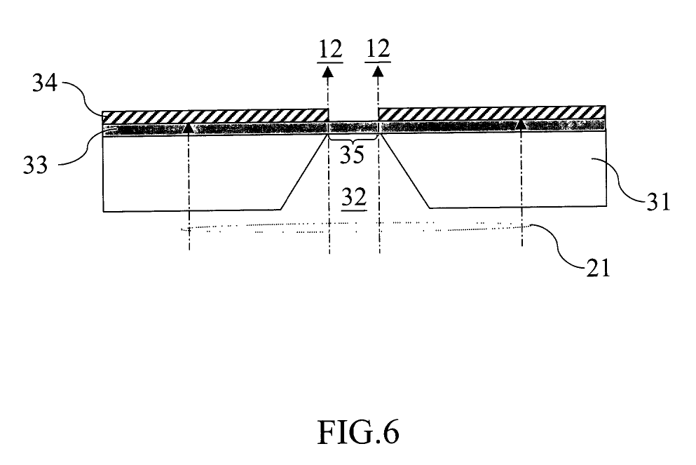

As shown in FIG. 6, a silicon substrate 31 with (100) orientation is provided. A bandpass optical film 33 is fabricated on one face of the silicon substrate 31. The bandpass optical film 33 is composed of multiple pairs of dielectrics. Each pair consists a high and a low refractive index dielectrics, usually being TiO₂/MgF₂. The thickness t thereof satisfy nt=λ/4, respectively, wherein n is the refractive index, and λ is the central wavelength of passing band. A V-groove 32 formed by anisotropic etching removes some of the silicon substrate 31 to expose some of the bandpass optical film 33, hence forming a diaphragm structure 35, which can prevent the silicon substrate 31 from absorbing specific spectrum (e.g., visible light). A spatial filter 34 is fabricated by metal film coating and etching. The material of the spatial filter 34 is usually Ti/Au or Cr/Au, wherein Ti and Cr is used as the adhesive layer.

Micro Tunable Filter

A Fabry-Perot (FP) tunable filter (using piezoelectric actuation conventionally) is composed of two high reflective mirrors, wherein an air cavity is adjustable. When the length of the resonant cavity is multiples of a half of a certain wavelength, the output light pulse will have a very narrow full width of half maximum (FWHM). The tunable filter is extensively used in optical communication and various kinds of spectrum detection equipments. However, conventional machining and assembly techniques make the FP tunable filter not owning wide free spectral range (FSR) characteristic. The main reason is that the length of resonant cavity is too large (FSR is inversely proportional to the length of resonant cavity). The micro tunable filter manufactured by micromachining technique can solve this problem. The spectral tuning range thereof can be as high as 1˜2 μm. This result let it have spectrometer function like the optical grating does (referring to U.S. Pat. No. 5,550,375), which cannot be achieved with the conventional FP one and is the utmost characteristic of the micro tunable filter. Moreover, low power dissipation and low cost of batch production similar to silicon IC are also factors of advantage.

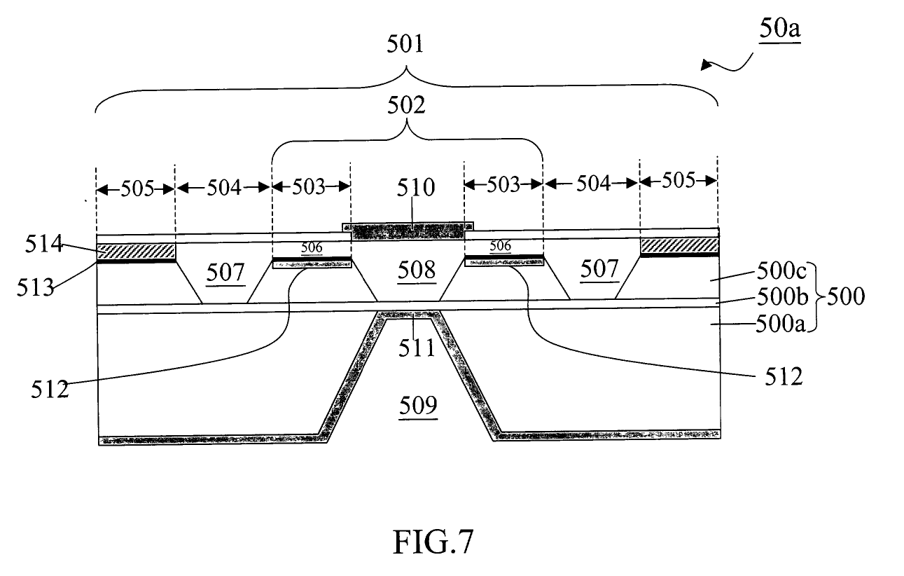

As shown in FIG. 7, the micro tunable filter 50a according to an embodiment of the present invention comprises a silicon substrate 500, which is silicon on insulator (SOI). The silicon substrate 10 has a silicon oxide insulator 500b therein, which separates the silicon substrate 500 into a front silicon wafer 500c (also termed device wafer) and a back silicon wafer 500a (also termed handle wafer).

A float mechanical structure 501 is at a distance of an air gap 506 from the surface of the front silicon wafer 500c. The float mechanical structure 501 includes a membrane structure 502, four supporting legs 504, and four fixed regions 505. An end point of the supporting leg 504 is connected to the membrane 502, and the other end point of the supporting leg 504 is connected to the fixed region 505. The fixed region 505 is connected to and fixed on the surface of the front silicon wafer 500c via a spacer 514. The thickness of the spacer 514 is the initial height of the air gap 506.

A first reflecting mirror 510 is fabricated at the center of the membrane structure 502. A float electrode 503 is fabricated on the membrane structure 502, and is connected to the fixed region 505 via the supporting leg 504 to achieve electric connection with the exterior.

A fixed electrode 512 is fabricated on the surface of the front silicon wafer 500c, and is exactly below the float electrode 503.

A plurality of V-grooves 507 and 508 are fabricated in the front silicon wafer 500c (including the resonant cavity V-grooves 508 below the first reflecting mirror 510 and the anti-sticking V-grooves 507 below the supporting leg 504). The silicon oxide 500b in the middle of the silicon substrate 500 is exposed in a square shape as being the flat square bottom of the resonant cavity V-groove 508. A backside V-groove 509 is formed from the backside of silicon wafer 500a resulting a same flat square bottom terminated at the silicon oxide 500b. A second reflecting mirror 511 is fabricated on the square and flat bottom of the backside V-groove 509.

The optical resonant cavity of the tunable filter of the present invention is formed between the two planar mirrors 510 and 511.

The optical resonant cavity of the present invention is fabricated by combining surface micromachining technique (polysilicon sacrificial layer etching) and the bulk micromachining technique (single crystal silicon anisotropic etching). The length of the optical resonant cavity is the sum of thickness of the front silicon wafer 500c and the air gap 506, and is usually determined by the thickness of the front silicon wafer 500c. The thickness of the front silicon wafer 500c can be of different specifications (0.3˜100 μm) from commercially available SOI, hence being very flexible. Through proper selection of the thickness of the front silicon wafer 500c, a balanced point between the optical tuning range and the spectrum resolution, i.e., a wide tuning spectral range as well as a satisfactory optical resolution can be obtained.

Through design and fabrication of the float electrode 503 and the fixed electrode 512, the length of the optical resonant cavity between the first reflecting mirror 510 and the second reflecting mirror 511 can be tuned by means of electric force. The spacing between the float electrode 503 and the fixed electrode 512 is defined by fabrication of sacrificial layer and subsequent etching action. Therefore, different air gaps 506 can be defined according to different necessities. Because the spacing is defined by the thickness of sacrificial layer (the thickness thereof is usually smaller than 3 μm), a lower voltage is needed for tuning the length of the optical resonant cavity.

The anti-sticking V-groove 507 is fabricated below the supporting leg 504 to avoid sticking caused by surface tension of etching solution.

Besides the above advantages, the first reflecting mirror 500 and the second reflecting mirror 511 have a very good degree of parallelism. Moreover, the special design of microstructure of the tunable filter let its spectral behavior not influenced by the absorption behavior of substrate 500. Through selection of the material of the first reflecting mirror 510 and the second reflecting mirror 511, tunable filters can be used in all spectrum not just IR range.

The fixed electrode 512 is fabricated on the surface of the front silicon wafer 500c by means of diffusion or ion implantation. The material of the spacer 514 is polysilicon. The mechanical structure 501 is a sandwich structure composed of three layers of materials, being silicon-rich nitride, polysilicon, and silicon-rich nitride, respectively. Silicon-rich nitride has a very good mechanical rigidity and a very low thermal residue stress (referring to Bruce C. S. Chou et al., “A method of fabricating low-stress dielectric thin film for micro detectors applications,” IEEE Electron Device Letters 18, 1997, p. 599˜601), and thus is most suitably used as micro mechanical structure of high quality and high stability. The polysilicon between the silicon rich nitrides is simultaneously used as the mechanical structure and the float electrode 503. The first and second reflecting mirror 510 and 511 are high-reflection low-absorption mirrors made of multiple pairs of dielectric. Each pair of dielectric materials with high and low refractive indices, usually being MgF₂/TiO₂. The thickness t thereof satisfy nt=λ/4, respectively, wherein n is the refractive index, and λ is the central wavelength of the tuned wavelength.

Micro Thermal Detector

Thermal detectors (bolometer, pyrometer, and thermopile) have the advantage of broad and flat spectral response and thus are suitable for calibration application. However, they have the drawback of low responsivity (V/W).

Along with development of silicon micromachining technique in 1980s, floating membrane structures (capable of reducing heat capacity) of high thermal isolation (low thermal conductance) greatly enhances the responsitivity and response speed of such devices. Therefore, micro thermal detectors advance more quickly, especially the micro thermopile detectors. The advantage of thermopile device is that it will not dissipate any power to avoid any voltage noise coupling from the power supply. Other thermo-resistive infrared devices cannot achieve this advantage. Moreover, because the current passing through the thermopile device is very small (even zero), low frequency noise (l/f noise) caused by the drive current can be omitted. When there is no incident radiation, the hot contact region and cold contact region of the thermopile can be thought the same. The influence of ambient drift to this kind of device is thus much smaller as compared to the other twos. Therefore, this kind of device is suitable for portable application and can operate at the room temperature, and needs no additional temperature-control device.

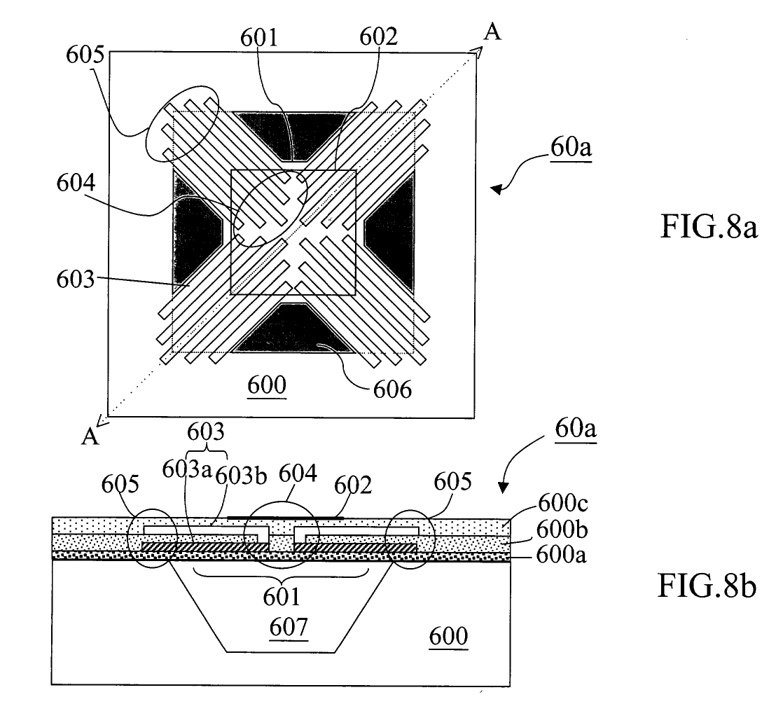

As shown in FIGS. 8a and 8b, a thermopile device 60a comprises a silicon substrate 600 with (100) orientation and a floating membrane 601 formed on the substrate 600 and having a plurality of thermocouples 603. A hot contact region 604 is at the central portion of the floating membrane 601. A cold contact region 605 is at the peripheral portion of the floating membrane 601. Defined by a plurality of etch windows 606, the V-groove 607 below the floating membrane 601 are etched out to form the structure of the floating membrane 601. An IR absorbing material 602 is fabricated on the utmost surface of the floating membrane 601. The IR absorbing material 602 is usually a very thin metal film (e.g., gold-black or platinum-black) for increasing absorption of radiation.

The floating membrane 601 comprises a first dielectric 600a, a first thermoelectric material 603a, a second dielectric 600b, a second thermoelectric material 603b, and a third dielectric 600c. The first, second, and third dielectrics are usually silicon oxide, silicon nitride, or their combination. The first and second thermoelectric materials are composed of n-type and p-type silicon conductors, or composed of a silicon conductor and a metal conductor.

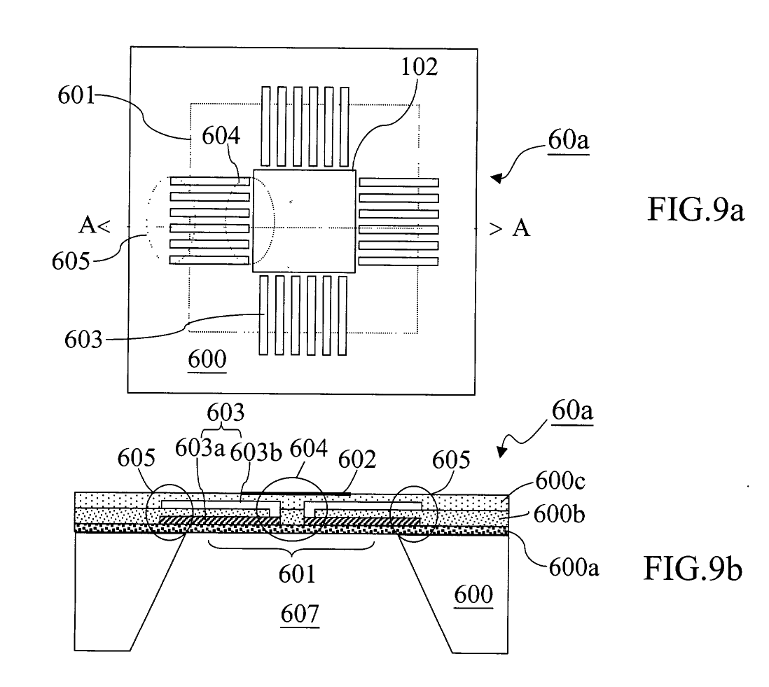

FIG. 9a is a top view of a micro thermopile detector according to another embodiment of the present invention. FIG. 9b is a cross-sectional view along line A-A of FIG. 9a. The structure shown in FIGS. 9a and 9b only differs from that shown in FIGS. 8a and 8b in that the V-groove 607 is formed by means of backside anisotropic etching.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A miniaturized infrared gas analyzing apparatus, comprising:
an infrared emitting unit utilizing the blackbody radiation principle of thermo-resistive filament to radiate out a wide infrared spectrum;
an infrared collimator for converting said infrared emitter unit to a collimated infrared light beam;
a bandpass and spatial filter for allowing the transmission of a wide passband including at least the absorption wavelength of a gas to be sensed and only letting the infrared light beam pass within a specific geometric region;
a Fabry-Perot tunable filter unit utilizing electric field to control the length of resonant cavity so that only the narrow-bandwidth light of the absorption spectrum of the sensed gas can pass;
a sensing unit determining the concentration of the sensed gas according to the intensity of incident narrow-bandwidth light; and
a microprocessing unit used for controlling of all the components mentioned above.

2. The apparatus as claimed in claim 1, wherein said infrared emitting unit comprises:
a micro thermo-resistive infrared emitter fabricated by means of silicon micromachining technique and radiating out light including various kinds of bands in all directions on the basis of blackbody radiation principle; and
an constant-temperature (-resistance) drive circuit for stabilizing the temperature of said micro thermo-resistive infrared emitter so that it will not be affected by drift of the room temperature to influence the existance of specific wavelength and reduce the sensitivity of measurement.

3. The apparatus as claimed in claim 2, wherein said micro thermo-resistive infrared emitter comprises:
a silicon substrate with (100) orientation and having a first and a second surfaces;
a V-groove fabricated by silicon anisotropic etching and on said first or second surface of said silicon substrate;
a floating membrane formed on said V-groove;
a thermo-resistive material fabricated in said floating membrane; and
a blackbody material fabricated on an utmost surface of said floating membrane to increase emissivity of light radiation.

4. The apparatus as claimed in claim 3, wherein said thermo-resistive material is silicon or platinum of high temperature coefficient of resistance.

5. The apparatus as claimed in claim 3, wherein said blackbody material is gold-black or platinum-black.

6. The apparatus as claimed in claim 1, wherein said bandpass and spatial filter comprises:
a silicon substrate with (100) orientation and having a first and a second surfaces;
a bandpass optical film fabricated on said first surface of said silicon substrate and allowing the transmission of a wide passband including at least the absorption wavelength of a specific gas to be sensed;
a metal layer having an opening of specific geometric shape as a spatial filter and fabricated on said bandpass optical film; and
a V-groove fabricated by silicon anisotropic etching, and an opening of said V-groove being formed on said second surface of said silicon substrate, said V-groove penetrating through said silicon substrate so that said bandpass optical film and the opening of specific geometric shape of said metal film as a spatial filter are exposed out of a square bottom of said V-groove.

7. The apparatus as claimed in claim 6, wherein said bandpass optical film is composed of multiple pairs of dielectrics, and the basic composite unit of said each pair is a high and a low refractive index dielectrics.

8. The apparatus as claimed in claim 6, wherein said metal film as a spatial filter is Ti/Au or Cr/Au, Ti and Cr being used as the adhesive layer.

9. The apparatus as claimed in claim 1, wherein said Fabry-Perot tunable filter unit further comprises:
a micro tunable filter fabricated by means of silicon micromachining technique and used for controlling electric field to change the length of resonant cavity so as to allow the infrared absorption wavelength of the sensed gas transmitting; and
a driving and oscillation circuit for providing a DC voltage and a oscillating AC voltage so that said micro tunable filter has both the functions of narrow bandpass filter and optical modulator.

10. The apparatus as claimed in claim 9, wherein said micro tunable filter comprises:
a silicon on insulator provided with a silicon oxide insulator to separate said silicon on insulator into a front silicon wafer and a back silicon wafer;
a floating mechanical structure comprising a membrane structure and at least a supporting leg, a first end point of said supporting leg being connected to said membrane structure, a second end point of said supporting leg being connected to at least a fixed region;
at least a spacer for connecting said fixed region and said front silicon wafer;
an air gap formed between said floating mechanical structure and a surface of said front silicon wafer, the initial distance of said air gap being determined by the height of said spacer;
a first reflecting mirror fabricated at the center of said membrane structure;
a floating electrode fabricated on said membrane structure, said floating electrode achieving electric connection with exterior via said supporting leg and said fixed region;
a fixed electrode fabricated on the surface of said front silicon wafer and exactly below said floating electrode, said fixed electrode being at a distance of said air gap from said floating electrode;
a resonant cavity V-groove fabricated in said front silicon wafer and exactly below said first reflecting mirror, said silicon oxide insulator in said silicon on insulator being exposed out of a square and flat bottom of said resonant cavity V-groove;
at least an anti-sticking V-groove fabricated in said front silicon wafer and exactly below said supporting leg;
a back trench fabricated in said back silicon wafer and aiming at said first reflecting mirror, said silicon oxide insulator in said silicon on insulator being exposed out of a flat bottom of said back trench; and
a second reflecting mirror fabricated at the flat bottom of said back trench.

11. The apparatus as claimed in claim 10, wherein said floating mechanical structure is a sandwich structure composed of silicon-rich nitride, polysilicon, and silicon-rich nitride in this order.

12. The apparatus as claimed in claim 10, wherein the material of said floating electrode is polysilicon.

13. The apparatus as claimed in claim 10, wherein the material of said spacer is polysilicon or amorphous silicon.

14. The apparatus as claimed in claim 10, wherein said first and second reflecting mirrors are highly reflective mirrors made of several pairs of dielectric materials of high/low refractive indices.

15. The apparatus as claimed in claim 1, wherein said sensing unit comprises:
a micro thermal detector fabricated by means of silicon micromachining technique; and
a frequency-locking readout circuit for comparing the output AC signal of said micro thermal detector with the modulation frequency of said driving and oscillation circuit to enhance the signal to noise ratio of measurement and avoid noise problem caused by environmental effect.

16. The apparatus as claimed in claim 15, wherein said micro thermal detector comprises:
a silicon substrate with (100) orientation and having a first and a second surfaces;
a V-groove fabricated by silicon anisotropic etching and formed on said first or second surface of said silicon substrate;
a floating membrane formed on said V-groove;
at least a thermocouple fabricated in said floating membrane, a hot contact region of said thermocouple being at the central portion of said floating membrane, a cold contact region of said thermocouple being at the peripheral portion of said floating membrane; and
a blackbody material fabricated on a surface of said floating membrane to enhance absorption of light radiation.

17. The apparatus as claimed in claim 16, wherein said thermocouple comprise a first and a second thermocouple materials, which are made of n-type and p-type silicon conductors or a silicon conductor and a metal conductor.

18. The apparatus as claimed in claim 16, wherein said blackbody material is gold-black or platinum-black.
